(19) United States
(12) Patent Application Publication
(10) Pub. No.: US 2016/0249773 A1
(43) Pub. Date: Sep. 1, 2016

(54) LIQUID AGITATION CONTAINER

(71) Applicant: William Elliott Van Pelt, (US)

(72) Inventors: William Elliott Van Pelt, East Haven, CT (US); Nicholas Vallo, New Albany, OH (US); Joel Beebe, Columbus, OH (US); Christos Ragias, New Albany, OH (US); Chris Brown, Columbus, OH (US)

(21) Appl. No.: 15/052,972

(22) Filed: Feb. 25, 2016

Related U.S. Application Data
(60) Provisional application No. 62/121,646, filed on Feb. 27, 2015.

(51) Int. Cl. A47J 43/27; A47G 19/22

(52) U.S. Cl. CPC A47J 43/27; A47G 19/2272; A47G 19/2288

(57) ABSTRACT

Various embodiments of a liquid agitation container are provided. In one embodiment, a liquid agitation container is provided, the container comprising: a cup including a bottom and a sidewall, and a cup interior defined by the bottom and the sidewall, wherein the cup includes at least one spiral element oriented on the sidewall and extending into the cup interior; and a lid removably connected to the cup, wherein the lid includes a compartment that opens onto a top surface of the lid, and wherein the lid includes a compartment closure removably connected to the lid to at least partially seal the compartment.

### CROSS-REFERENCE TO RELATED APPLICATIONS

This application claims priority from U.S. Provisional Patent Application No. 62/121,646, filed on Feb. 27, 2015, which is incorporated by reference herein in its entirety.

### BACKGROUND

While there are many types of cups that are travel friendly for individuals constantly on the go, some common problems that individuals may encounter include cups that lack an adequate seal to resist leaking when the substance inside the cup is shaken or swirled. This sealing becomes essential in instances where an individual desires to mix a solid powder substance with a liquid substance inside a cup via shaking or swirling of the cup. In most instances, to properly and thoroughly create a homogeneous mixture, vigorous shaking and stirring is required. For example, athletes and individuals on specific diets often require protein shakes, which are a mixture of liquid (such as milk or water) and powder (such as powdered protein), that require vigorous mixing to fully dissolve the powder into the liquid. In another example, other types of recreational drinks, such as Gatorade®, Crystal Light®, hot chocolate, instant coffee, and the like, are also available as powders to be mixed with water.

What is needed is a cup that allows an individual to store and travel with a powder and/or liquid. The cup may be specifically designed to be selectively liquid-tight. The cup may also aid in the mixing of the powder with the liquid such that the resulting mixture eliminates or minimizes the number of undissolved clumps of powder.

### SUMMARY

In one embodiment, a liquid agitation container is provided, the container comprising: a cup including a bottom and a sidewall, and a cup interior defined by the bottom and the sidewall, wherein the cup includes at least one spiral element oriented on the sidewall and extending into the cup interior; and a lid removably connected to the cup, wherein the lid includes a compartment that opens onto a top surface of the lid, and wherein the lid includes a compartment closure removably connected to the lid to at least partially seal the compartment.

In another embodiment, a liquid agitation container is provided, the container comprising: a cup including a bottom and a sidewall, and a cup interior defined by the bottom and the sidewall, wherein the cup includes at least one spiral element oriented on the sidewall and extending into the cup interior, and wherein the cup includes a first rigid agitator extending from the bottom of the cup into the cup interior; and a lid removably connected to the cup, wherein the lid includes a second rigid agitator extending from a bottom of the lid into the cup interior, and wherein the lid includes a compartment defined by the second rigid agitator, wherein the compartment opens onto a top surface of the lid.

In one embodiment, a lid for a drinking cup is provided, the lid comprising: a top surface and a bottom surface; a rigid agitator extending from the bottom surface of the lid; a compartment defined by the second rigid agitator, wherein the compartment opens onto the top surface of the lid; and a compartment closure removably connected to the lid to at least partially seal the compartment.

In one embodiment, a drinking cup is provided, the drinking cup comprising: a bottom; a sidewall; a cup interior defined by the bottom and the sidewall; at least one spiral element oriented on the sidewall and extending into the cup interior; and a first rigid agitator extending from the bottom of the cup into the cup interior.

In another embodiment, a drinking cup is provided, the drinking cup comprising: a bottom; an outer sidewall; an inner sidewall; a cup interior defined by the bottom and the inner sidewall; and at least one spiral element oriented on the inner sidewall and extending into the cup interior.

### BRIEF DESCRIPTION OF THE DRAWINGS

The accompanying figures, which are incorporated in and constitute a part of the specification, illustrate various example configurations, and are used merely to illustrate various example embodiments. In the figures, like elements bear like reference numerals.

FIG. 1A illustrates a side perspective view of an example embodiment of a cup and lid system.

FIG. 1B illustrates a side transparent view of an example embodiment of a cup and lid system.

FIG. 1C illustrates a side perspective view of an example embodiment of a cup and lid system wherein the lid and cup are not attached.

FIG. 1D illustrates a top plan view of an example embodiment of a cup.

FIG. 1E illustrates a side perspective view of an example embodiment of a transparent cup.

FIG. 1F illustrates a side perspective view of an example embodiment of a lid and a supplement lid for storage.

FIG. 1G illustrates a top plan view of an example embodiment of a lid and a supplement lid for storage.

FIG. 2A illustrates a top plan view of an example embodiment of a lid.

FIG. 2B illustrates a side transparent view of an example embodiment of a cup and lid system.

FIG. 3A illustrates a top plan view of an example embodiment of a lid.

FIG. 3B illustrates a side transparent view of an example embodiment of a cup and lid system.

FIG. 4A illustrates a top plan view of an example embodiment of a lid.

FIG. 4B illustrates a side transparent view of an example embodiment of a cup and lid system.

FIG. 5A illustrates a top plan view of an example embodiment of a lid.

FIG. 5B illustrates a side transparent view of an example embodiment of a cup and lid system.

### DETAILED DESCRIPTION

Dissolving a powder into a liquid can be difficult when it is done outside the comfort of one's own kitchen. This is especially true in instances where the powder tends to form clumps in the liquid, requiring an individual to use more than the cursory amount of stirring required when dissolving sugars or salts into a liquid. Powders that form clumps have amphipathic properties, meaning that the molecule, such as a protein, contain both hydrophilic and hydrophobic parts. In such instances, some parts of the powder will bond well with water, while other parts would rather bond with non-aqueous solutions such as oil. This property makes powders that contain substances such as proteins difficult to dissolve without a blender or other very vigorous manual methods of agitation. Such methods, while effective, are not practical for the modern active needs of many individuals who are often on the go or who do not have the aforementioned appliances or tools. Additionally, such methods are not practical for individuals who wish to prepare drinks, including protein shakes, at the gym or perhaps while traveling following a gym session. The liquid agitation container described herein may include a cup and lid system that is specially designed to aid in the agitation of the powder and liquid combination while maintaining a seal that prevents the liquid from spilling out of the container during vigorous shaking and swirling of the system. The liquid agitation container described herein may be used to aid in de-clumping pockets of powder in a liquid. The liquid agitation container described herein may be used to store a powder in a compartment of the lid.

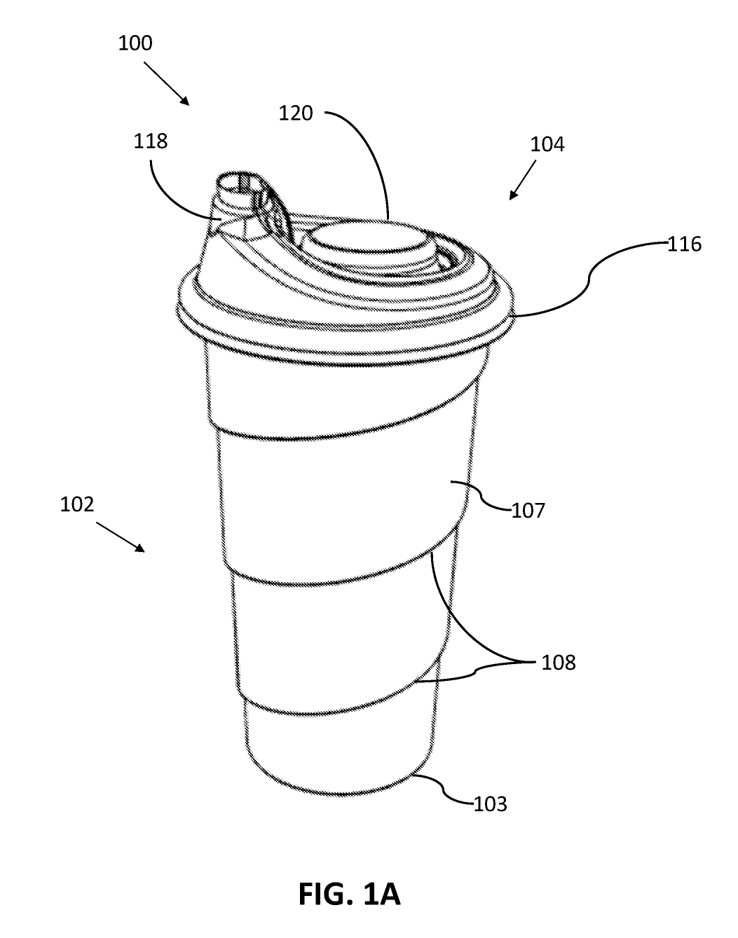

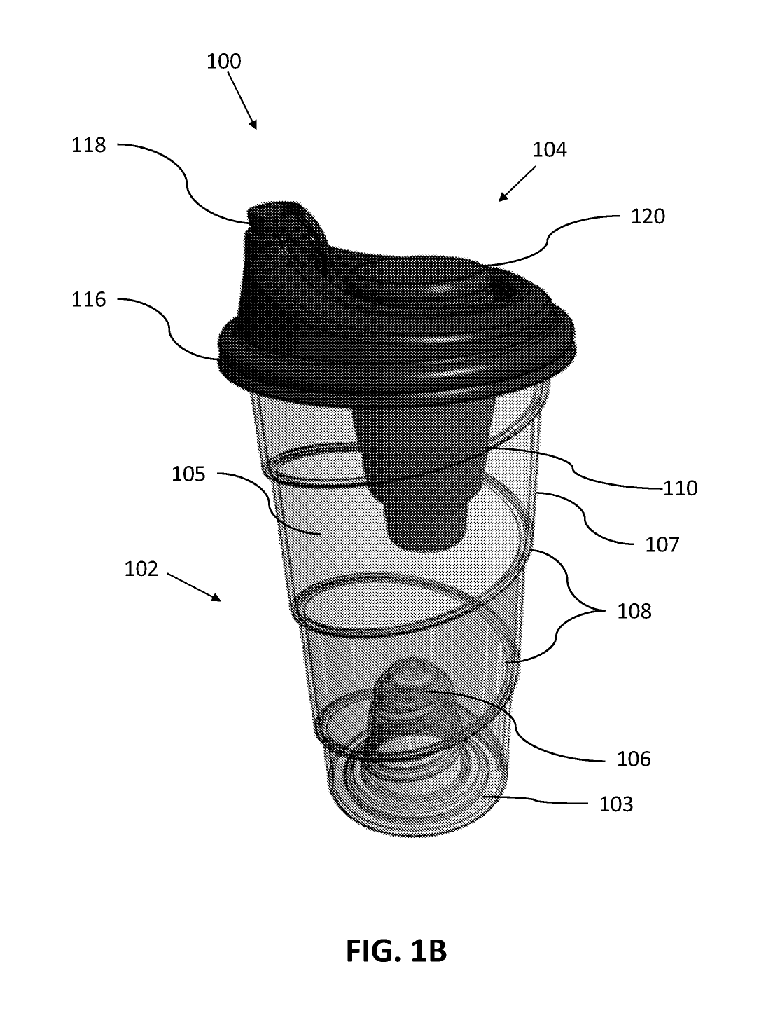

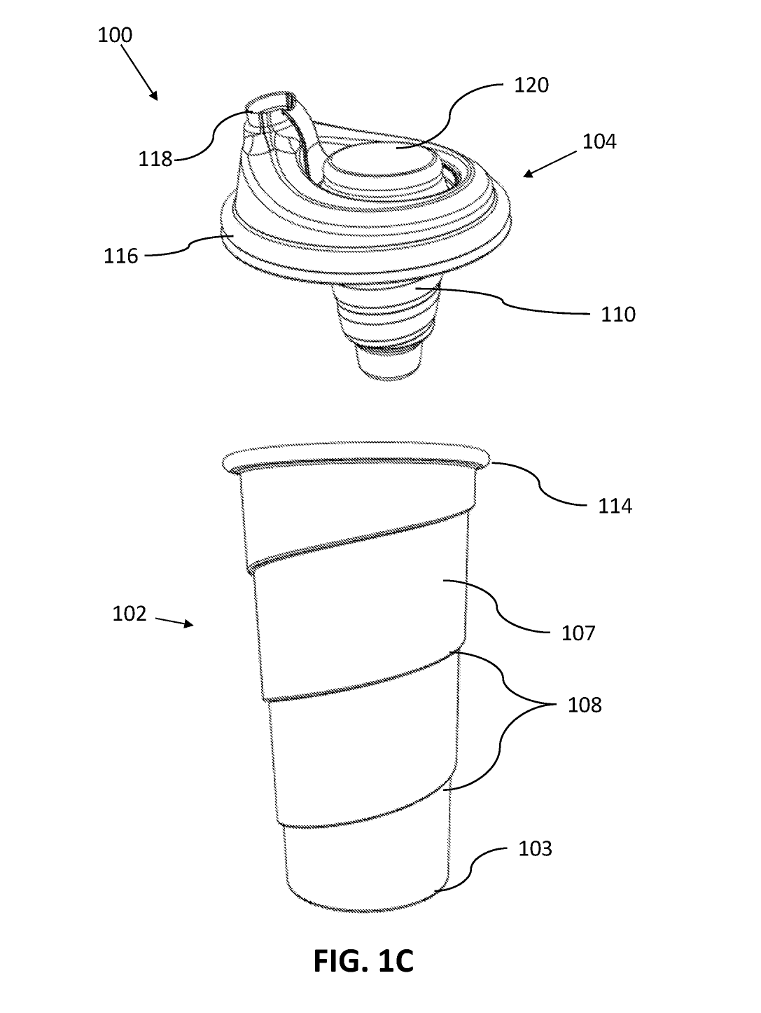

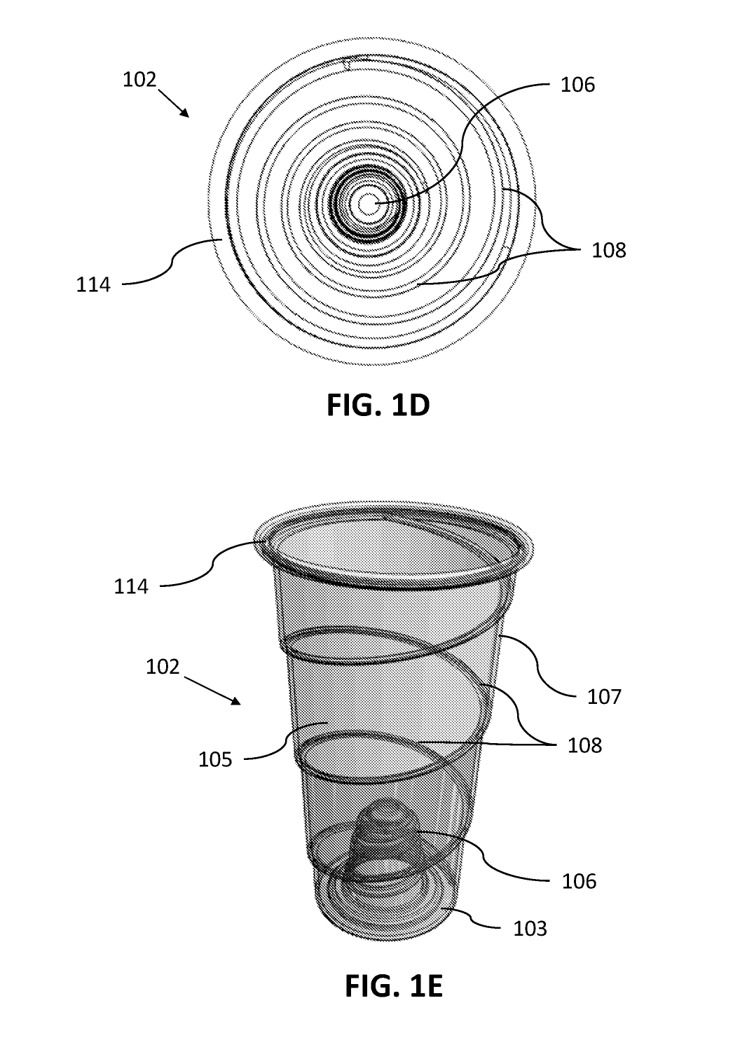

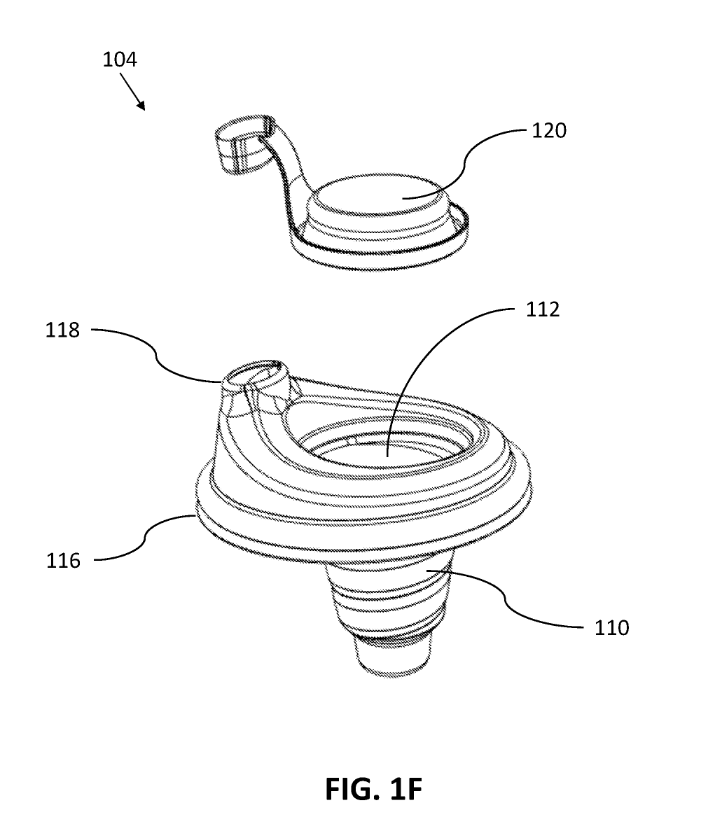

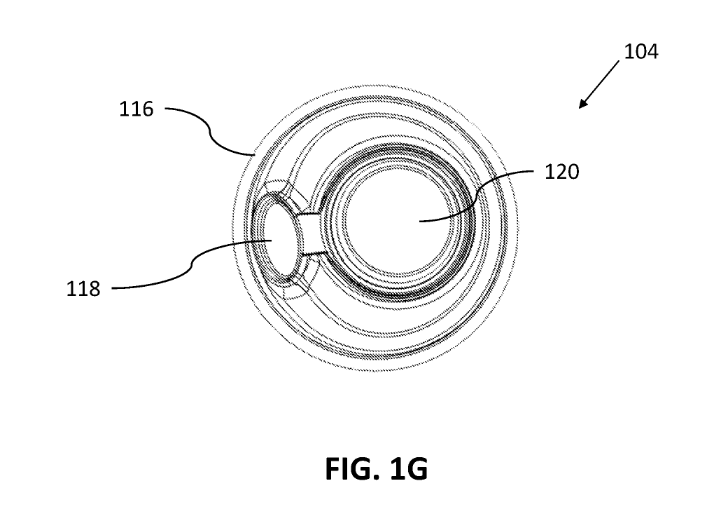

FIG. 1A illustrates liquid agitation container 100 including a cup 102 and a lid 104. Cup 102 may include a spiral element 108 along sidewall 107 of cup 102 to aid in the agitation process. Cup 102 may also contain a lip 114 (illustrated in FIG. 1C), which may be removably connected to a rim 116 of lid 104, as illustrated in FIG. 1C. Lid 104 may contain a drinking aperture 118 located adjacent to the periphery of rim 116. Drinking aperture 118 may be selectively closed and sealed by a compartment closure 120, wherein compartment closure 120 may be removably connected to lid 104 to form a water-tight seal over drinking aperture 118.

Cup 102 may include a substantially circular cross-section. Cup 102 may be shaped generally cylindrically. Cup 102 may be shaped generally as a truncated cone. Cup 102 may include a bottom 103, and at least one sidewall 107. Cup 102 may have an open top, permitting the addition or removal of items into the interior of the cup, including for example a liquid for drinking. Cup 102 may be open within the middle of lip 114. Bottom 103 may be substantially flat to permit cup 102 to balance upon a surface, such as a table top. Bottom 103 and sidewall 107 may be integrally connected. Bottom 103 and sidewall 107 may be connected in a liquid tight manner. Bottom 103, sidewall 107, and lid 104 may together enclose a cup interior 105.

Cup 102 may comprise any of a variety of materials, including for example a polymer, a metal, an alloy, a composite, an organic material, an inorganic material, and the like.

Lid 104 may be substantially circular in cross-section. Lid 104 may have a cross-section that is substantially similar to that of cup 102. Lid 104 may have a cross-section that is substantially similar to that of lip 114.

Lid 104 may comprise any of a variety of materials, including for example a polymer, a metal, an alloy, a composite, an organic material, an inorganic material, and the like.

Lid 104 may be removably connected to cup 102. Rim 116 of lid 104 may selectively engage lip 114 via any of a variety of mechanisms. For example, rim 116 may engage lip 114 via a friction fit between the two. Rim 116 may engage lip 114 via a friction fit between the two, wherein lip 114 forms a rib and rim 116 includes a groove. Rim 116 may engage lip 114 via threads.

Drinking aperture 118 may comprise an aperture, hole, perforation, etc. allowing a user to remove an item from cup interior 105. Drinking aperture 118 may include a passage allowing a liquid to pass from cup interior 105. Drinking aperture 118 may be selectively sealed by at least a portion of compartment closure 120. Compartment closure 120 may include any element configured to engage at least a portion of drinking aperture 118 so as to at least partially prevent passage of a liquid therethrough, thus at least partially preventing a liquid to escape cup interior 105. Compartment closure 120 may include a snap fit element, interference fit element, friction fit element, and the like configured to fit within, about, or both, drinking aperture 118. Lid 104 may include a compartment 112 (illustrated in FIG. 1F) defined by a second rigid agitator 110 (illustrated in FIG. 1B), such that compartment 112 is oriented within second rigid agitator 110. Drinking aperture 118 may be used for drinking the contents of cup 102.

Compartment 112 may be configured to retain an item, and may be selectively sealed by an element of compartment closure 120. Compartment closure 120 may include any element configured to engage at least a portion of compartment 112 so as to at least partially prevent passage of a substance from compartment 112. Compartment closure 120 may include a snap fit element, interference fit element, friction fit element, and the like configured to fit within, about, or both, compartment 112. Compartment 112 may be configured to contain a liquid, a solid, or any item. Compartment 112 may be configured to contain a powder, such as a protein powder or other supplement, sugar, drink mix, hot chocolate mix, and the like. Compartment 112 may be configured to contain a liquid, such as a coffee creamer, energy drink, concentrated drink mix, and the like.

FIG. 1B illustrates a transparent image of the liquid agitation container 100 from FIG. 1A. The transparent image shows that cup 102 may contain a first rigid agitator 106 extending upward from the base of the cup. The liquid agitation container may also contain second rigid agitator 110 extending downward from the bottom of lid 104. The extension of second rigid agitator 110 may form corresponding compartment 112 on the surface of lid 104, as can be seen in FIGS. 1E and 1F. Compartment 112 may be suitable as supplemental storage for various powders which may be subsequently mixed with a liquid in liquid agitation container 100. Compartment closure 120 may be used to close and seal the various powders in compartment 112, while also sealing drinking aperture 118, whereby the entire liquid agitation container 100 may be moved without concern over the possibility of spilling the liquid or powder content.

As is more clearly illustrated in FIG. 1B, spiral element 108 may be oriented in sidewall 107, and may extend into cup interior 105. Spiral element 108 may create ridges on sidewall 107 that is in contact with cup interior 105. As a result, shaking or swirling of container 100 may cause elements within cup 102 to impact or otherwise engage spiral element 108, thus facilitating improved mixing of those elements, breaking up of clumped elements, and the like. Liquid contents of cup 102 may engage spiral element 108 such that spiral element 108 may induce a stirring action within the liquid contents, thus facilitating improved mixing of elements within cup 102.

Similarly, container 100 may include at least one of first rigid agitator 106 and second rigid agitator 110. As a result, shaking or swirling of container 100 may cause elements within cup 102 to impact or otherwise engage first rigid agitator 106 and/or second rigid agitator 110, thus facilitating improved mixing of those elements, breaking up of clumped elements, and the like.

Container 100 may include at least one of spiral element 108, first rigid agitator 106, and second rigid agitator 110. Elements to be mixed within cup 102 may contact at least one of spiral element 108, first rigid agitator 106, and second rigid agitator 110 during shaking or swirling of container 100, thus facilitating improved mixture of those elements.

In one embodiment, the liquid agitation container may be used to mix powders into liquids. The powder may be hydrophilic, hydrophobic, or amphiphilic in nature, including but not limited to salts, proteins, and the like, while the liquid may be an aqueous solution, a solvent, or an emulsion of a combination thereof.

In one embodiment, spiral element 108 along sidewall 107 of cup 102 may aid in the agitation process by encouraging the undissolved clumps of powder to stick to the ridges inside the walls of the cup created by the spirals, thus increasing the surface area of the non-dissolved powders and increasing the likelihood of being broken up through continued agitation.

In one embodiment, first rigid agitator 106 may aid in the agitation process by increasing the surface area of undissolved clumps of powder such that the clumps can break open during the agitation process, thus increasing the likelihood of an increased mixing of elements within cup 102. First rigid agitator 106 may also comprise other means to aid in the agitation process including, but not limited to, ridged spirals, bumps, a smooth surface, a matted surface, or the like.

In one embodiment, second rigid agitator 110 may aid in the agitation process by increasing the surface area of undissolved clumps of powder such that the clumps can break open during the agitation process, thus increasing the likelihood of an increased mixing of elements within cup 102. Second rigid agitator 110 may also comprise other means to aid in the agitation process including, but not limited to, ridged spirals, bumps, a smooth surface, a matted surface, or the like.

As more clearly illustrated in FIGS. 1B and 1C, at least one of first rigid agitator 106 and second rigid agitator 110 may include a spiraled exterior surface to further facilitate mixing of elements within cup 102, in the same manner as described above with respect to spiral element 108.

FIG. 1D illustrates a top view of cup 102, which may contain first rigid agitator 106 extending upward from the bottom of cup 102. This figure also illustrates a top view of spiral element 108 along sidewall 107 of cup 102. Also illustrated is a top view of lip 114.

FIG. 1E illustrates a side perspective view of cup 102.

FIG. 1F illustrates a side view of lid 104, which may include second rigid agitator 110 extending downward from the bottom of lid 104. Compartment 112 may be defined by second rigid agitator 110. Compartment 112 may open into the top of lid 104. Compartment closure 120 may be removable from lid 104.

FIG. 1G illustrates a top view of lid 104, which may contain compartment 112 on the surface of the drinking lid 104.

In one embodiment, liquid agitator container 100 may include any of a variety of materials, including without limitation, a polymer, a plastic, a metal, an alloy, a composite, or the like.

In one embodiment, the cup 102 may be stackable with other cups 102.

In one embodiment, the surface of sidewall 107 in contact with cup interior 105 is coated with a slippery resin to enhance the cleaning of cup interior 105 following its use.

In one embodiment, liquid agitator container 100 is disposable. Liquid agitator container 100 may be made from recycled materials. Liquid agitator container 100 may be made of a closed-cell polystyrene. Liquid agitator container 100 may be made from a cardboard or paper product.

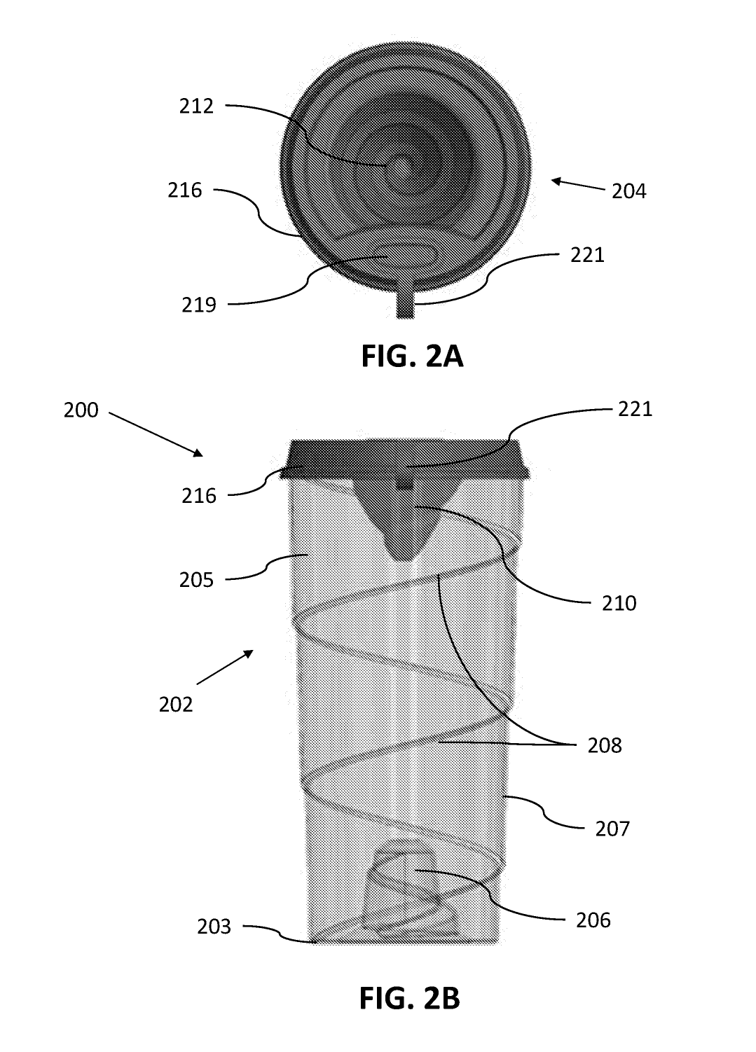

FIGS. 2A-5B illustrate additional possible embodiments of the liquid agitation container.

FIG. 2A illustrates a top view of a liquid agitation container 200. FIG. 2B illustrates a side view of liquid agitation container 200. Container 200 may include a cup 202 with a lip (not shown). Container 200 may include a lid 204 with a rim 216. Lid 204 may include a drinking aperture 218, and a drinking aperture closure 219, which may be attached peripherally to rim 216 by a lanyard 221. Liquid agitation container 200 may also include a compartment 212, a first agitator 206, a second agitator 210, and at least one spiral element 208 oriented along the sidewall 207 of cup 202. A cup interior 205 may be defined by sidewall 207 and a cup bottom 203.

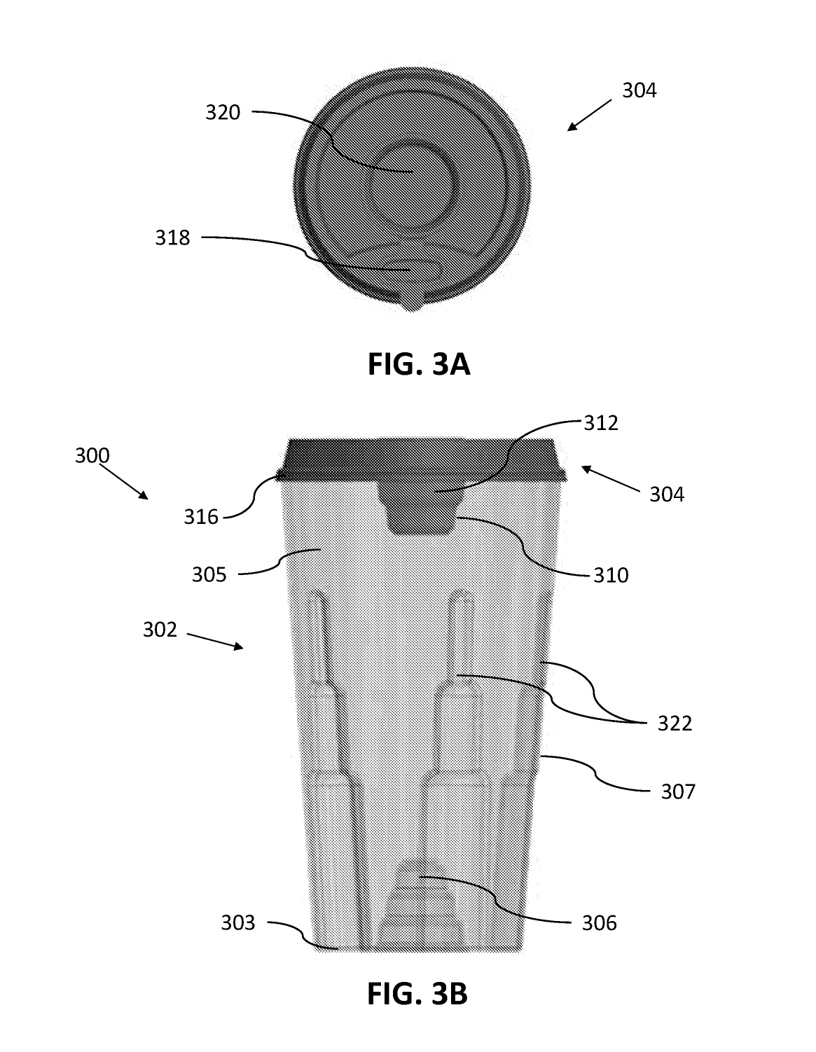

FIG. 3A illustrates a top view of a liquid agitation container 300. FIG. 3B illustrates a side view of liquid agitation container 300. Container 300 may include a cup 302 with a lip (not shown). Container 300 may include a lid 304 with a rim 316. Lid 304 may include a drinking aperture 318. Drinking aperture 318 may be closed and at least partially sealed by a compartment closure 320. Compartment closure 320 may be removably connected to lid 304 to form a liquid-tight seal over drinking aperture 318. Container 300 may also include a cavity 312, a first agitator 306, a second agitator 310, and at least one stepped element 322 oriented on a sidewall 307 of the cup. A cup interior 305 may be defined by sidewall 307 and a cup bottom 303.

At least one of first agitator 306 and second agitator 310 may include a stepped profile. These elements, in addition to at least one stepped element 322, may facilitate improved mixing of contents of container 300 and cup 302, via a similar mixing mechanism as described above with respect to first agitator 106, second agitator 110, and at least one spiral element 108 in container 100.

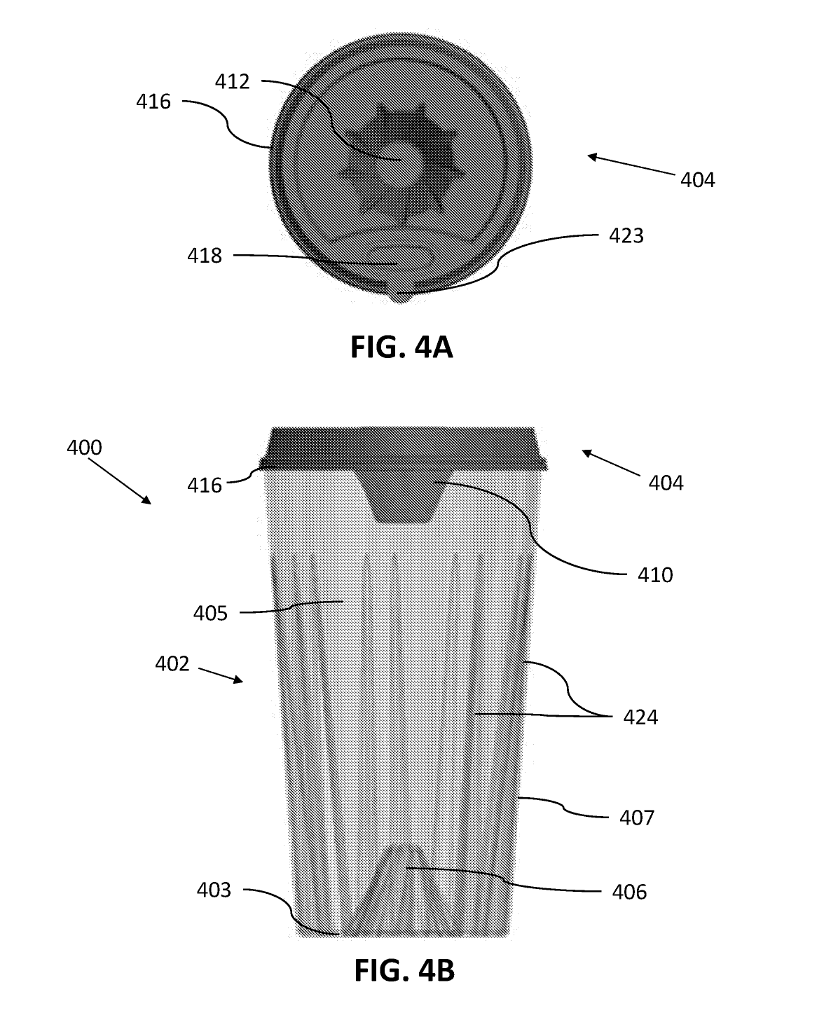

FIG. 4A illustrates a top view of a liquid agitation container 400. FIG. 4B illustrates a side view of liquid agitation container 400. Container 400 may include a cup 402 with a lip (not shown). Container 400 may include a lid 404 with a rim 416. Lid 404 may include a drinking aperture 418. Lid 404 may include a drinking aperture closure 423, which may include a pull tab to be torn from lid 404 to open drinking aperture 404. Container 400 may include a cavity 412, a first agitator 406, a second agitator 410, and at least one longitudinal rib 424 oriented in a sidewall 407 of cup 402. A cup interior 405 may be defined by sidewall 407 and a cup bottom 403.

At least one of first agitator 406 and second agitator 410 may include at least one longitudinal rib. These elements, in addition to at least one longitudinal rib 424, may facilitate improved mixing of contents of container 400 and cup 402, via a similar mixing mechanism as described above with respect to first agitator 106, second agitator 110, and at least one spiral element 108 in container 100.

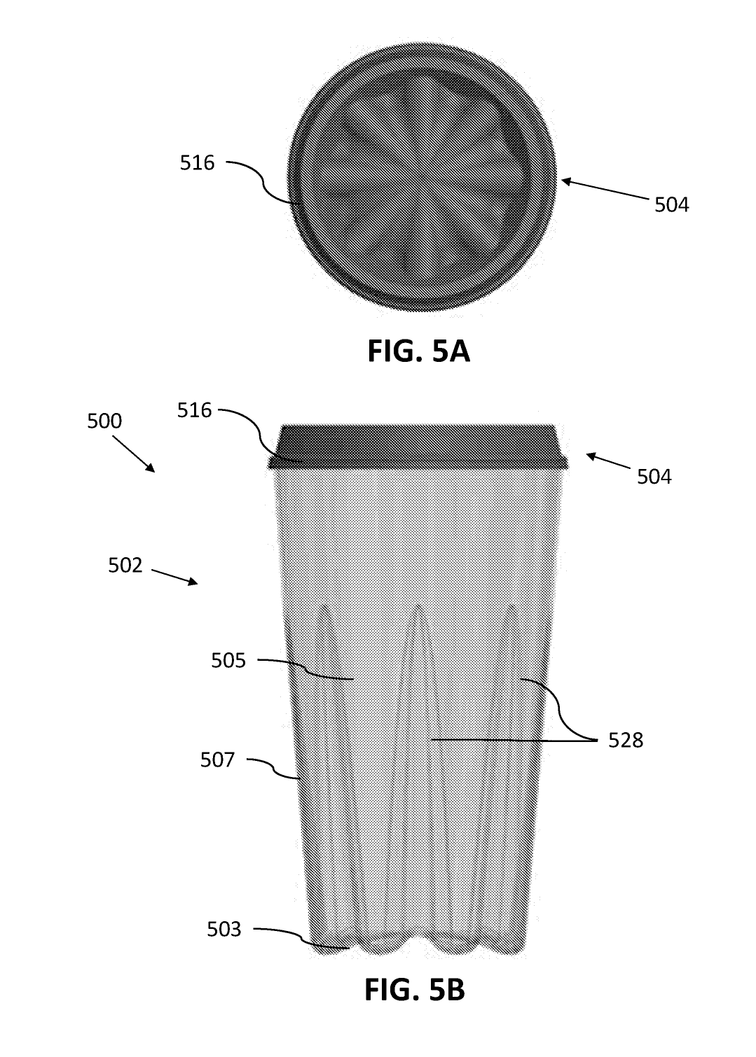

FIG. 5A illustrates a top view of a liquid agitation container 500. FIG. 5B illustrates a side view of liquid agitation container 500. Container 500 may include a cup 502 with a lip (not shown). Container 500 may include a lid 504 with a rim 516. Container 500 may include at least one longitudinal rib 528 oriented in a sidewall 507 of cup 502. A cup interior 505 may be defined by sidewall 507 and a cup bottom 503.

At least one longitudinal rib 528, may facilitate improved mixing of contents of container 500 and cup 502, via a similar mixing mechanism as described above with respect to first agitator 106, second agitator 110, and at least one spiral element 108 in container 100.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A lid for a drinking cup, comprising:
a top surface and a bottom surface;
a rigid agitator extending from the bottom surface of the lid;
a compartment defined by the second rigid agitator, wherein the compartment opens onto the top surface of the lid; and
a compartment closure removably connected to the lid to at least partially seal the compartment.

2. A drinking cup, comprising:
a bottom;
a sidewall;
a cup interior defined by the bottom and the sidewall;
at least one spiral element oriented on the sidewall and extending into the cup interior; and
a first rigid agitator extending from the bottom of the cup into the cup interior.

3. A drinking cup, comprising:
a bottom;
an outer sidewall;
an inner sidewall;
a cup interior defined by the bottom and the inner sidewall; and
at least one spiral element oriented on the inner sidewall and extending into the cup interior.
